(19) United States
(12) Patent Application Publication
(10) Pub. No.: US 2025/0309981 A1
(43) Pub. Date: Oct. 2, 2025

(54) OPTICAL TRANSMISSION PATH MONITORING DEVICE AND OPTICAL TRANSMISSION PATH MONITORING METHOD

(71) Applicant: Fujitsu Limited, Kawasaki-shi (JP)

(72) Inventor: KAZUYUKI TAJIMA, Yokosuka (JP)

(73) Assignee: Fujitsu Limited, Kawasaki-shi (JP)

(21) Appl. No.: 19/034,215

(22) Filed: Jan. 22, 2025

(30) Foreign Application Priority Data
Mar. 28, 2024 (JP) 2024-054157

(51) Int. Cl. H04B 10/079; H04B 10/2513

(52) U.S. Cl. CPC H04B 10/07955; H04B 10/07951; H04B 10/25133

(57) ABSTRACT

An optical transmission path monitoring device includes: a first compensation circuit that compensates for a part of wavelength dispersion of an optical transmission path with respect to an electric field signal indicating an optical electric field component of an optical signal; a non-linear compensation circuit that compensates for degradation of the optical transmission path; a second compensation circuit that compensates for remaining wavelength dispersion of the optical transmission path excluding the part of the wavelength dispersion, and compensates for wavelength dispersion at a virtual position; an adjustment circuit that adjusts a compensation amount; a third compensation circuit that compensates for the wavelength dispersion of the compensation amount; and an estimation circuit that estimates optical power based on a correlation of amplitude between a first signal output from the second compensation circuit and a second signal output from the third compensation circuit.

### CROSS-REFERENCE TO RELATED APPLICATION

This application is based upon and claims the benefit of priority of the prior Japanese Patent Application No. 2024-54157, filed on Mar. 28, 2024, the entire contents of which are incorporated herein by reference.

### FIELD

The embodiments discussed herein are related to an optical transmission path monitoring device and an optical transmission path monitoring method.

### BACKGROUND

There is known a transmission path monitoring device including a first compensation unit that compensates for a part of wavelength dispersion of a transmission path with respect to an electric field signal indicating an optical electric field component of an optical signal obtained by digital coherent reception from the transmission path. In addition, there is known a transmission path monitoring device including a second compensation unit that compensates for degradation of the transmission path caused by a non-linear optical effect with respect to the electric field signal compensated by the first compensation unit. Moreover, there is known a transmission path monitoring device including a third compensation unit that compensates for remaining wavelength dispersion of the transmission path excluding the part of the wavelength dispersion with respect to the electric field signal compensated by the second compensation unit.

Japanese Laid-open Patent Publication No. 2018-133725 is disclosed as related art.

### SUMMARY

According to an aspect of the embodiments, an optical transmission path monitoring device includes: a first compensation circuit that compensates for a part of wavelength dispersion of an optical transmission path with respect to an electric field signal that indicates an optical electric field component of an optical signal obtained by digital coherent reception from the optical transmission path; a non-linear compensation circuit that compensates for degradation of the optical transmission path caused by a non-linear optical effect with respect to the electric field signal compensated by the first compensation circuit; a second compensation circuit that compensates for remaining wavelength dispersion of the optical transmission path excluding the part of the wavelength dispersion with respect to the electric field signal compensated by the non-linear compensation circuit, and additionally compensates for wavelength dispersion at a virtual position deviated from the optical transmission path with respect to the compensated electric field signal; an adjustment circuit that adjusts a compensation amount additionally compensated by the second compensation circuit; a third compensation circuit that compensates for the wavelength dispersion of the compensation amount with respect to a reference signal that indicates the optical electric field component of the optical signal at a transmission end of the optical transmission path; and an estimation circuit that estimates optical power in a vicinity of the transmission end based on a correlation of amplitude between a first signal output from the second compensation circuit and a second signal output from the third compensation circuit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an exemplary optical transmission system;

FIG. 2 is an exemplary hardware configuration of an optical reception device and an optical transmission path monitoring device;

FIG. 3 is an exemplary functional configuration of a digital signal processor (DSP) and a field programmable gate array (FPGA) according to a first embodiment;

FIG. 4 is a diagram for explaining an example of additional compensation according to the first embodiment;

FIG. 5 is a diagram for explaining an example of setting values according to the first embodiment;

FIG. 6 is an exemplary power profile according to a comparative example;

FIG. 7 is an exemplary power profile according to a working example;

FIG. 8 is a flowchart illustrating exemplary operation of the optical transmission path monitoring device according to the first embodiment;

FIG. 9 is an exemplary functional configuration of a DSP and an FPGA according to a modification of the first embodiment;

FIG. 10 is a part of a flowchart illustrating exemplary operation of an optical transmission path monitoring device according to a second embodiment;

FIG. 11 is a diagram for explaining an example of setting values according to the second embodiment;

FIG. 12 is a diagram for explaining an example of additional compensation according to the second embodiment;

FIG. 13 is an example of a partial functional configuration of an FPGA according to a third embodiment;

FIG. 14A is an exemplary functional configuration of an estimated sensitivity correction unit according to the third embodiment; FIG. 14B is an exemplary coefficient database (DB);

FIG. 15 is an exemplary power profile according to the third embodiment;

FIG. 16A is an exemplary functional configuration of an estimated sensitivity correction unit according to a fourth embodiment; FIG. 16B is an exemplary correction function;

FIG. 17 is an exemplary functional configuration of a DSP and an FPGA according to a fifth embodiment;

FIG. 18 is a part of a flowchart illustrating exemplary operation of an optical transmission path monitoring device according to the fifth embodiment;

FIG. 19 is an exemplary functional configuration of a DSP and an FPGA according to a sixth embodiment; and

FIG. 20 is a part of a flowchart illustrating exemplary operation of an optical transmission path monitoring device according to the sixth embodiment.

### DESCRIPTION OF EMBODIMENTS

The second compensation unit described above compensates for the degradation caused by the non-linear optical effect by giving phase reverse rotation proportional to power of the input electric field signal. As a result, phase rotation proportional to the power of the electric field signal itself called self-phase modulation (SPM) is compensated.

Only an argument of a complex number changes in the second compensation unit. Thus, magnitude of a first electric field signal input to the second compensation unit and magnitude of a second electric field signal output from the second compensation unit do not change and are equal. The subsequent third compensation unit compensates for the wavelength dispersion, thereby changing the waveform of the second electric field signal. For example, the magnitude of the second electric field signal output from the second compensation unit and input to the third compensation unit is different from magnitude of a third electric field signal output from the third compensation unit.

However, when the compensation amount of the third compensation unit is zero or close to zero, the magnitude of the first electric field signal, second electric field signal, and third electric field signal does not change and is equal. For example, when the compensation amount of the third compensation unit is zero or close to zero, the compensation effect of the second compensation unit is reduced. Therefore, in the vicinity of a transmission end where the compensation amount of the third compensation unit is zero or close to zero, accuracy in estimating the optical power may be lowered.

In view of the above, in one aspect, an object is to provide an optical transmission path monitoring device and an optical transmission path monitoring method for accurately estimating optical power in the vicinity of a transmission end.

Hereinafter, modes for carrying out the present case will be described with reference to the drawings.

### First Embodiment

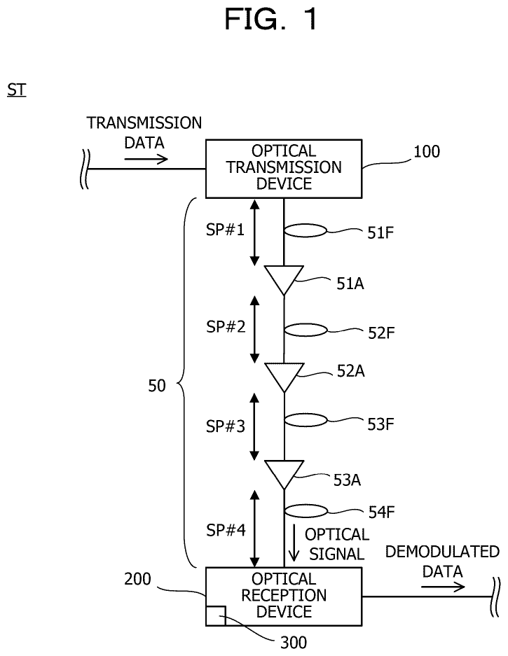

As illustrated in FIG. 1, an optical transmission system ST includes an optical transmission device 100 as a transmission end and an optical reception device 200 as a reception end. The optical transmission device 100 and the optical reception device 200 are coupled by an optical transmission path 50. When transmission data is input, the optical transmission device 100 transmits optical signals obtained by modulating the transmission data to the optical transmission path 50. The optical signals propagate through the optical transmission path 50. The optical reception device 200 receives, from the optical transmission path 50, the optical signals transmitted from the optical transmission device 100, and demodulates them to output demodulated data.

A plurality of optical amplifiers 51A, 52A, and 53A is provided in the optical transmission path 50. Thus, the optical transmission path 50 is divided into a plurality of transmission sections (which will be referred to as spans hereinafter) SP #1, SP #2, SP #3, and SP #4 by the optical amplifiers 51A, 52A, and 53A. For example, the optical transmission path 50 is a multi-span optical transmission path including the plurality of spans SP #1, SP #2, SP #3, and SP #4 (which will be appropriately described as SP #1, . . . , and SP #4 hereinafter).

Optical fibers 51F, 52F, 53F, and 54F are laid in each of the plurality of spans SP #1, . . . , and SP #4. For example, a standard single mode fiber (SSMF) is laid as an optical fiber in the spans SP #1, . . . , and SP #4. A dispersion shifted fiber (DSF) may be laid as an optical fiber in some or all of the spans SP #1, . . . , and SP #4.

Note that lengths of the optical fibers 51F, 52F, 53F, and 54F are not particularly limited, and in the present embodiment, the length of each of the optical fibers 51F, 52F, 53F, and 54F will be described as several tens of kilometers (km) as an example. For example, each path length of the plurality of spans SP #1, . . . , and SP #4 is several tens of kilometers, and the total path length obtained by totalizing the respective path lengths is several hundred kilometers.

The optical reception device 200 includes an optical transmission path monitoring device 300. The optical transmission path monitoring device 300 may be provided separately from the optical reception device 200. In this case, the optical transmission path monitoring device 300 may be included in an optical network controller that manages the optical transmission system ST. The optical transmission path monitoring device 300 monitors (performs monitoring of) characteristics of the optical transmission path 50. Although details will be described later, the optical transmission path monitoring device 300 obtains an electric field signal indicating an optical electric field component of the optical signal received by the optical reception device 200.

When the optical transmission path monitoring device 300 obtains the electric field signal, it estimates optical power of the optical signal at a plurality of positions in the optical transmission path 50 based on the electric field signal. The optical transmission path monitoring device 300 may generate a power profile including the estimated optical power based on the estimated optical power. The power profile may represent the characteristics of the optical transmission path 50. If the power profile can be accurately generated, the optical transmission path monitoring device 300 is enabled to accurately detect a position of an abnormal loss generated in the vicinity of the optical transmission device 100 based on the power profile. Furthermore, a surveillance monitor for displaying the power profile, the position of the abnormal loss, and the like may be coupled to the optical transmission path monitoring device 300. With this arrangement, for example, a person in charge of operation of the optical transmission system ST is enabled to check the power profile, the position of the abnormal loss, and the like.

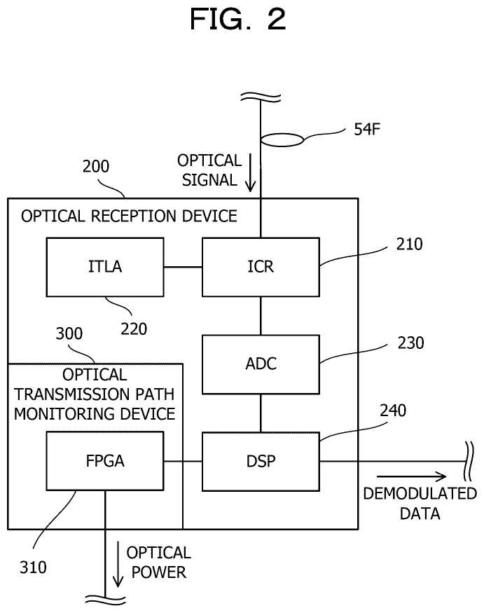

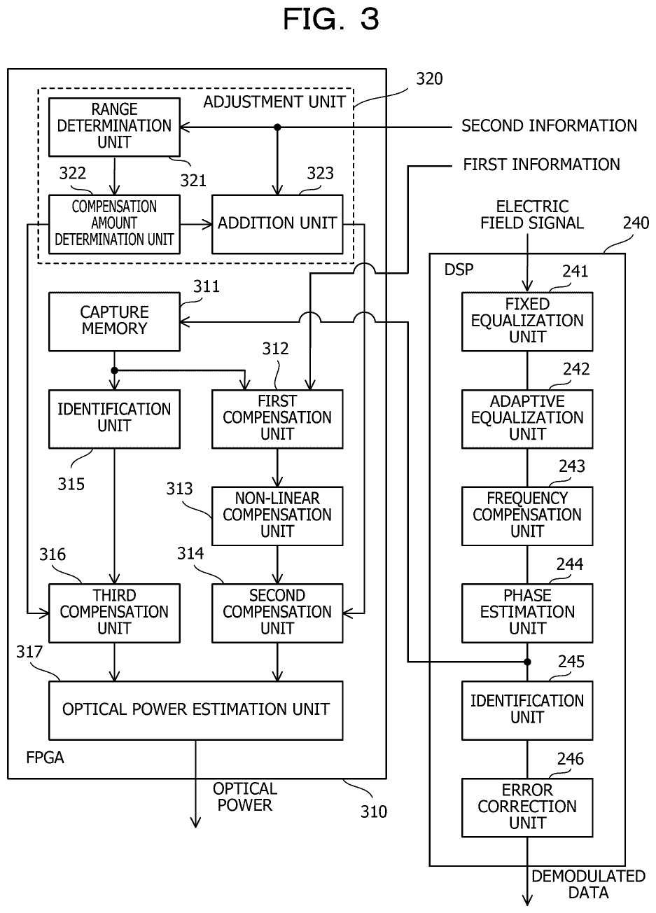

Next, details of the optical reception device 200 and the optical transmission path monitoring device 300 will be described with reference to FIGS. 2 and 3.

As illustrated in FIG. 2, the optical reception device 200 includes an integrated coherent receiver (ICR) 210 and an integrable tunable laser assembly (ITLA) 220. Although illustration is omitted, the ICR 210 includes a 90-degree optical hybrid circuit and a balanced photo diode (BPD). The ICR 210 is an integrated circuit in which the 90-degree optical hybrid circuit and the BPD are stored in one package. Furthermore, the optical reception device 200 includes an analog-digital converter (ADC) 230 and a DSP 240.

An optical signal having passed through the optical fiber 54F is input to the ICR 210. The ITLA 220 is a local oscillation light source that outputs local oscillation light (e.g., laser light). The ICR 210 receives the optical signal by the local oscillation light, converts the received optical signal into an electric field signal (e.g., electric field information signal) corresponding to the optical signal, and outputs it to the ADC 230. The ADC 230 converts the electric field signal from an analog format to a digital format, and outputs it to the DSP 240.

The DSP 240 receives the electric field signal output from the ADC 230, and performs various digital signal processing on the received electric field signal. As illustrated in FIG. 3, the DSP 240 includes a fixed equalization unit 241, an adaptive equalization unit 242, a frequency compensation unit 243, a phase estimation unit 244, an identification unit 245, and an error correction unit 246.

The fixed equalization unit 241 compensates for wavelength dispersion received by the optical signal propagating through the optical transmission path 50 with respect to the electric field signal received by the DSP 240. The fixed equalization unit 241 outputs the electric field signal after compensating for the wavelength dispersion to the adaptive equalization unit 242. The adaptive equalization unit 242 adaptively compensates for residual dispersion with respect to the electric field signal output from the fixed equalization unit 241. The residual dispersion is wavelength dispersion that remains without being compensated by the fixed equalization unit 241. The adaptive equalization unit 242 outputs the electric field signal after compensating for the residual dispersion to the frequency compensation unit 243.

The frequency compensation unit 243 compensates for a frequency offset with respect to the electric field signal output from the adaptive equalization unit 242. The frequency offset is a difference (or deviation) between an optical frequency of a transmission light source (not illustrated) included in the optical transmission device 100 and an optical frequency of the ITLA 220. The frequency compensation unit 243 outputs the electric field signal after compensating for the frequency offset to the phase estimation unit 244. The phase estimation unit 244 compensates for a phase offset with respect to the electric field signal output from the frequency compensation unit 243, and estimates a phase of the optical signal. The phase offset is a phase difference (deviation) between the transmission light source and the ITLA 220. The phase estimation unit 244 outputs the electric field signal after compensating for the phase offset to the identification unit 245.

The identification unit 245 demodulates the transmission data by identifying a value of each symbol based on the electric field signal output from the phase estimation unit 244, and outputs it to the error correction unit 246 as demodulated data. The error correction unit 246 corrects a bit error of the demodulated data, and outputs the demodulated data after correcting the error.

Meanwhile, as illustrated in FIG. 2, the optical transmission path monitoring device 300 includes an FPGA 310 as a hardware circuit. The optical transmission path monitoring device 300 may include, instead of the FPGA 310, an application specific integrated circuit (ASIC) as a hardware circuit. The optical transmission path monitoring device 300 may include, instead of the FPGA 310, a central processing unit (CPU) as a processor.

The FPGA 310 receives the electric field signal output from the DSP 240, and performs various digital signal processing on the received electric field signal. As illustrated in FIG. 3, the FPGA 310 includes a capture memory 311, a first compensation unit 312, a non-linear compensation unit 313, and a second compensation unit 314. Furthermore, the FPGA 310 includes an identification unit 315, a third compensation unit 316, an optical power estimation unit 317, and an adjustment unit 320. Note that the adjustment unit 320 includes a range determination unit 321, a compensation amount determination unit 322, and an addition unit 323. The first compensation unit 312, the non-linear compensation unit 313, the second compensation unit 314, the third compensation unit 316, the optical power estimation unit 317, the adjustment unit 320, and the like are implemented by the FPGA 310 executing a program according to a flowchart to be described later. Furthermore, an optical transmission path monitoring method of the present case is implemented by the FPGA 310 executing a program according to a flowchart to be described later.

The capture memory 311 retains the electric field signal output from the phase estimation unit 244 as a capture signal. The electric field signal output from the phase estimation unit 244 is a signal after the wavelength dispersion is compensated by the fixed equalization unit 241. Thus, a dispersion amount of the wavelength dispersion included in the capture signal is 0 (zero) picosecond/nanometer (ps/nm).

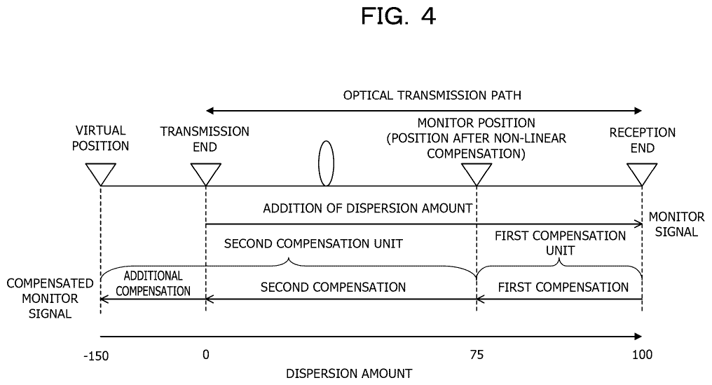

As illustrated in FIG. 3, the first compensation unit 312 obtains the capture signal from the capture memory 311. When the first compensation unit 312 obtains the capture signal, it compensates for a part of the wavelength dispersion of the optical transmission path 50 with respect to the capture signal. For example, as illustrated in FIG. 4, the first compensation unit 312 adds the wavelength dispersion of the entire optical transmission path 50, for example, from the transmission end to the reception end, and compensates for the wavelength dispersion from the reception end to the monitor position (referred to as first compensation in FIG. 4). Meanwhile, since the wavelength dispersion is addable, it may be rephrased that the first compensation unit 312 adds the wavelength dispersion from the transmission end to the monitor position. This is because the difference between the compensation and the addition is merely a difference in the sign of the dispersion amount.

As illustrated in FIG. 3, first information is set in the first compensation unit 312. The first information is a total value of a first dispersion compensation amount input value and a dispersion addition amount of the entire optical transmission path 50. For example, 100 ps/nm is adopted as the dispersion addition amount. The dispersion addition amount corresponds to, for example, a transmission path dispersion amount calculated in advance based on a dispersion coefficient and a distance of the optical transmission path 50. The first information is given by the following mathematical formula (1) as a first dispersion compensation amount setting value.

First dispersion compensation amount setting value=first dispersion compensation amount input value−dispersion addition amount <Mathematical Formula (1)>

In this manner, 100 ps/nm is added to the first dispersion compensation amount input value as the dispersion addition amount of the wavelength dispersion generated in the entire optical transmission path 50.

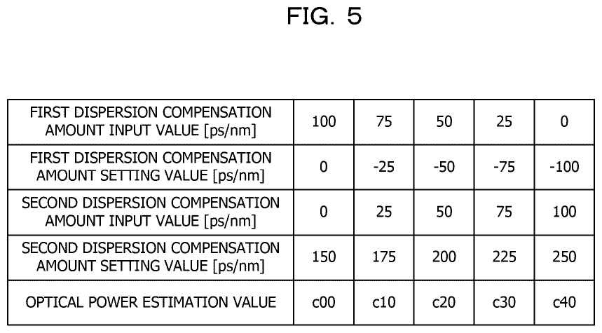

Thus, as illustrated in FIGS. 4 and 5, when the first dispersion compensation amount input value is 75 ps/nm, for example, the first dispersion compensation amount setting value is calculated as −25 ps/nm based on the mathematical formula (1). A minus sign of the dispersion compensation amount indicates addition of the dispersion amount. As illustrated in FIG. 5, the first compensation unit 312 reads all the first dispersion compensation amount input values at the monitor position at intervals of 25 ps/nm from 0 ps/nm to 100 ps/nm, and calculates the first dispersion compensation amount setting value. Upon calculation of the first dispersion compensation amount setting value, the first compensation unit 312 sets the first dispersion compensation amount setting value to itself. Note that the first compensation unit 312 may read the first dispersion compensation amount input value from a lookup table included in the optical reception device 200, or may read it from an external device coupled to the optical reception device 200. The first compensation unit 312 outputs, to the non-linear compensation unit 313, the capture signal after the dispersion of the optical transmission path 50 is added (or compensated) as a monitor signal.

As illustrated in FIG. 3, the non-linear compensation unit 313 compensates for degradation of the optical transmission path 50 caused by a non-linear optical effect with respect to the monitor signal compensated by the first compensation unit 312. Examples of the non-linear optical effect include a Kerr effect. When the Kerr effect occurs, a refractive index of the optical fiber of the optical transmission path 50 changes in proportion to the square of the power of the optical signal. As a result, self-phase modulation occurs in the optical signal so that the pulse width becomes narrower due to a change in the phase speed of light, which may be a cause of a signal error. The non-linear compensation unit 313 compensates for the degradation of the optical transmission path 50 caused by the non-linear optical effect by performing phase rotation by an amount obtained by multiplying the square of amplitude of the monitor signal by a predetermined value.

The second compensation unit 314 compensates for the remaining wavelength dispersion of the optical transmission path 50 with respect to the monitor signal compensated by the non-linear compensation unit 313. Moreover, the second compensation unit 314 additionally compensates for wavelength dispersion at a virtual position deviated from the optical transmission path 50 with respect to the monitor signal compensated by the second compensation unit 314. For example, as illustrated in FIG. 4, the second compensation unit 314 compensates for the wavelength dispersion from the monitor position to the transmission end (referred to as second compensation in FIG. 4). Moreover, the second compensation unit 314 compensates for the wavelength dispersion from the transmission end to the virtual position (referred to as additional compensation in FIG. 4).

Here, as illustrated in FIG. 3, second information is set in the range determination unit 321. The second information is a second dispersion compensation amount input value. As illustrated in FIG. 5, the range determination unit 321 reads all the second dispersion compensation amount input values at the monitor position at intervals of 25 ps/nm from 0 ps/nm to 100 ps/nm. Upon reading of the second dispersion compensation amount input values, the range determination unit 321 examines the minimum value and the maximum value of the dispersion amount from the monitor position to the transmission end, thereby obtaining a range of the dispersion amount taken by the optical transmission path 50.

As illustrated in FIG. 4, the additional dispersion compensation amount is out of the range of the dispersion amount that may be taken by the optical transmission path 50. Thus, the compensation amount determination unit 322 determines an additional dispersion compensation amount to be a value smaller than the minimum value of the dispersion amount obtained by the range determination unit 321 by a predetermined value or a value larger than the maximum value by a predetermined value. The predetermined value may be appropriately determined by design, experiment, or the like within a range in which the effects of the present embodiment may be exerted. In the first embodiment, an exemplary case will be described in which the compensation amount determination unit 322 determines a value smaller than the minimum value of the dispersion amount by a predetermined value.

According to FIG. 5, the minimum value of the second dispersion compensation amount input value is 0 ps/nm. Thus, the compensation amount determination unit 322 determines the additional dispersion compensation amount to be 150 ps/nm so that the residual dispersion becomes-150 ps/nm, which is smaller than the minimum value by a predetermined value, for example, 150 ps/nm. Note that the predetermined value may be set in the compensation amount determination unit 322 in advance. The compensation amount determination unit 322 outputs the determined additional dispersion compensation amount to the addition unit 323, and sets the same in the third compensation unit 316.

The addition unit 323 adds the second dispersion compensation amount input value and the additional dispersion compensation amount to calculate a second dispersion compensation amount setting value. For example, the addition unit 323 calculates the second dispersion compensation amount setting value based on the following mathematical formula (2).

Second dispersion compensation amount setting value=second dispersion compensation amount input value+additional dispersion compensation amount <Mathematical Formula (2)>

Thus, in the first embodiment, the addition unit 323 sets the compensation amount obtained by adding 150 ps/nm as the additional dispersion compensation amount to the second dispersion compensation amount input value in the second compensation unit 314.

The identification unit 315 obtains the capture signal retained in the capture memory 311, reproduces a symbol from the capture signal, and demodulates the capture signal by identifying a value of each symbol to reproduce a transmission signal (e.g., replica of the transmission signal). The identification unit 315 may use a transmission signal prepared in advance without reproducing the transmission signal. Upon reproduction of the transmission signal, the identification unit 315 outputs the transmission signal to the third compensation unit 316 as a reference signal.

The third compensation unit 316 compensates for the reference signal with the compensation amount set by the compensation amount determination unit 322. The reference signal input to the third compensation unit 316 does not include a dispersion amount. For example, the dispersion amount of the reference signal is 0 ps/nm. When the reference signal is not subject to the compensation, the dispersion amount included in the monitor signal output from the second compensation unit 314 is different from the dispersion amount included in the reference signal. When the dispersion amount of the monitor signal is different from the dispersion amount of the reference signal, the dispersion amounts do not correspond to each other in the optical power estimation unit 317 at the subsequent stage, and the correlation of the complex amplitude between the monitor signal and the reference signal may not be accurately calculated. Thus, the third compensation unit 316 also compensates for the reference signal in a similar manner to the monitor signal. According to the first embodiment, the third compensation unit 316 compensates for the reference signal with the compensation amount of 150 ps/nm set by the compensation amount determination unit 322. The third compensation unit 316 outputs the compensated reference signal to the optical power estimation unit 317 at the subsequent stage.

The optical power estimation unit 317 calculates, for each dispersion amount (e.g., cumulative dispersion amount), a correlation value of the complex amplitude of the monitor signal and the reference signal based on the monitor signal output from the second compensation unit 314 and the reference signal output from the third compensation unit 316. Upon calculation of the correlation value, the optical power estimation unit 317 outputs the calculated correlation value as an estimated value of optical power for each dispersion amount. Since the magnitude of the self-phase modulation corresponds to the optical power at the monitor position, the optical power estimation unit 317 is enabled to output the correlation value as an estimated value of the optical power.

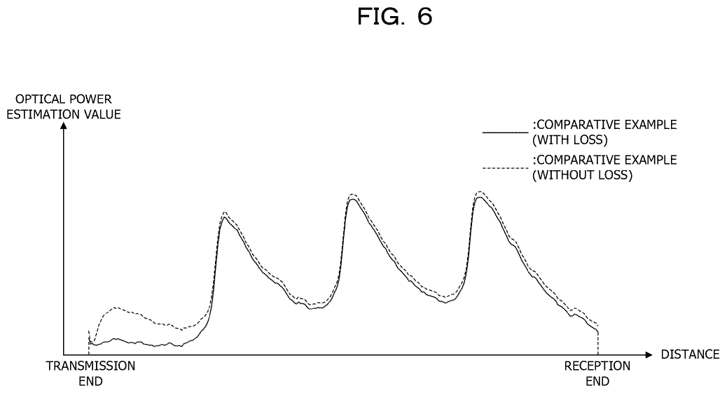

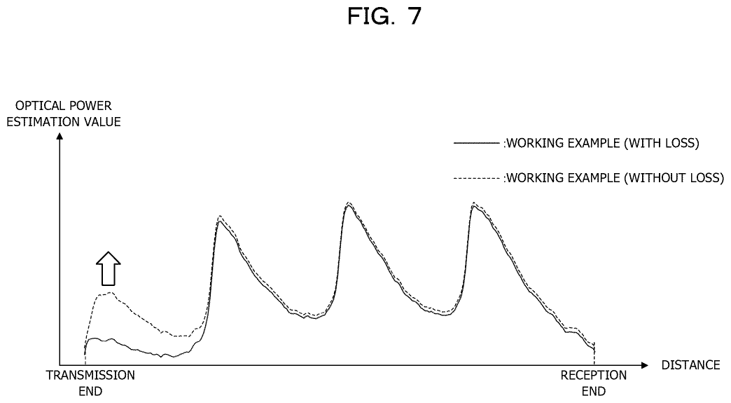

For example, as illustrated in FIG. 5, when 75 ps/nm is given as the first dispersion compensation amount input value and 25 ps/nm is given as the second dispersion compensation amount input value, the optical power estimation unit 317 outputs c10 as the estimated value of the optical power. Note that the optical power estimation unit 317 may generate a power profile based on the estimated value of the optical power. For example, for the generation of the power profile, Japanese Laid-open Patent Publication No. 2023-178193 may be referred to. As illustrated in FIGS. 6 and 7, the horizontal axis of the power profile represents a distance from the transmission end, and the vertical axis of the power profile represents an estimated value of the optical power. The horizontal axis of the power profile may represent a cumulative dispersion amount from the transmission end. For example, the horizontal axis of the power profile may represent a cumulative dispersion amount, or may represent a distance from the transmission end converted from the cumulative dispersion amount.

As a result, as indicated by a broken line in FIG. 6, in a case of a comparative example in which no abnormal loss occurs in the optical transmission path 50, the optical power in the vicinity of the transmission end decreases once and then increases, and the accuracy in the optical power estimation is lowered. In contrast, as indicated by a broken line in FIG. 7, in a working example in which no abnormal loss occurs in the optical transmission path 50, the optical power in the vicinity of the transmission end gradually increases without decreasing even once, and the accuracy in the optical power estimation improves. As described above, according to the first embodiment, the optical transmission path monitoring device 300 is enabled to accurately estimate the optical power in the vicinity of the transmission end.

Note that, although illustration is omitted, a detection unit that detects a position of an abnormal loss generated in the vicinity of the transmission end may be provided at a subsequent stage of the optical power estimation unit 317. For example, when an abnormal loss is intentionally generated at a position belonging to the span SP #1, which is 3 km away from the transmission end of the optical transmission path 50, the shape of the power profile changes as indicated by respective solid lines in FIGS. 6 and 7.

As illustrated in the comparative example in FIG. 6, there is a difference between the power profile of the solid line in which the abnormal loss occurs and the power profile of the broken line in which no abnormal loss occurs. The detection unit obtains the difference between those two power profiles, and detects a differential value of the difference as an index value of an abnormal loss occurrence position. Since this difference is larger at the position where the abnormal loss has occurred, when a change point at which this difference becomes larger is obtained, the position thereof corresponds to the abnormal loss occurrence position. In the comparative example, the detection unit detects the abnormal loss occurrence position as 4.5 km. Since the abnormal loss is generated at the position 3 km away from the transmission end of the optical transmission path 50, the error is 1.5 km.

Meanwhile, in the working example in FIG. 7, the detection unit detects the abnormal loss occurrence position as 3.5 km. Since the abnormal loss is generated at the position 3 km away from the transmission end of the optical transmission path 50, the error is 0.5 km. According to the first embodiment, the error is reduced to approximately one-third, and the accuracy in detecting the abnormal loss occurrence position improves approximately three times.

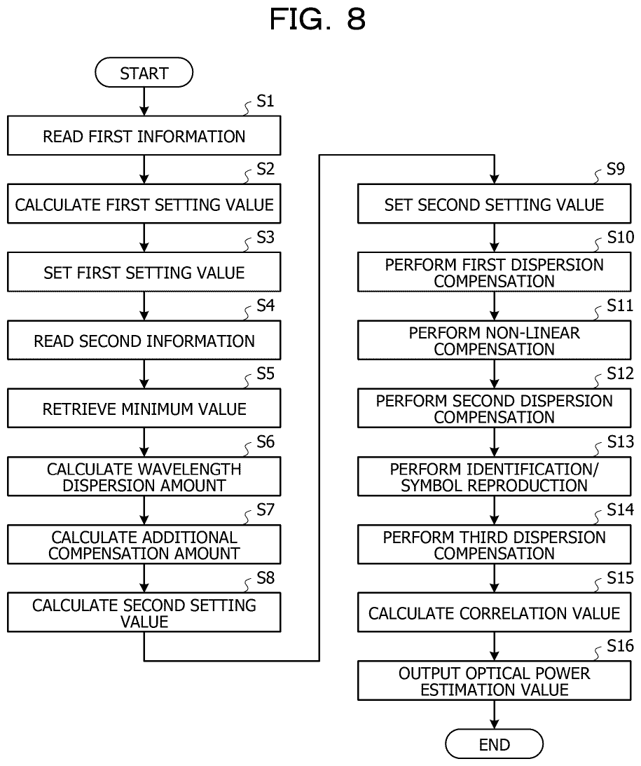

Operation of the optical transmission path monitoring device 300 will be described with reference to FIG. 8.

First, the first compensation unit 312 reads the first information (step S1). For example, the first compensation unit 312 reads, as the first information, all the first dispersion compensation amount input values at the monitor position. Upon reading of the first information, the first compensation unit 312 calculates a first setting value (step S2). For example, the first compensation unit 312 calculates, as the first setting value, the first dispersion compensation amount setting value based on the mathematical formula (1) mentioned above.

Upon calculation of the first setting value, the first compensation unit 312 sets the first setting value (step S3). For example, the first compensation unit 312 sets the first setting value to itself. When the first compensation unit 312 sets the first setting value, the range determination unit 321 reads the second information (step S4). For example, the range determination unit 321 reads, as the second information, all the second dispersion compensation amount input values at the monitor position.

Upon reading of the second information, the range determination unit 321 searches for the minimum value (step S5). In the first embodiment, the range determination unit 321 reads the second dispersion compensation amount input values from 0 ps/nm to 100 ps/nm at intervals of 25 ps/nm. Thus, when the range determination unit 321 searches for the minimum value, the range determination unit 321 identifies 0 ps/nm as a search result.

After the minimum value is searched for, the compensation amount determination unit 322 calculates a wavelength dispersion amount (step S6). For example, the compensation amount determination unit 322 calculates the wavelength dispersion amount obtained by subtracting the predetermined value described above from the minimum value. As a result, for example, the compensation amount determination unit 322 calculates −150 ps/nm as the wavelength dispersion amount. Upon calculation of the wavelength dispersion amount, the compensation amount determination unit 322 calculates an additional compensation amount (step S7). For example, the compensation amount determination unit 322 calculates the additional compensation amount by inverting the sign of the wavelength dispersion amount. In this manner, the compensation amount determination unit 322 determines the additional compensation amount, and sets the additional compensation amount in the third compensation unit 316.

When the compensation amount determination unit 322 determines the additional compensation amount, the addition unit 323 calculates a second setting value (step S8). For example, the addition unit 323 adds the additional compensation amount to the second dispersion compensation amount input value based on the mathematical formula (2) mentioned above, thereby calculating the second setting value as the second dispersion compensation amount setting value. Upon calculation of the second setting value, the addition unit 323 sets the second setting value (step S9). For example, the addition unit 323 sets the second setting value in the second compensation unit 314.

When the addition unit 323 sets the second setting value, the first compensation unit 312 carries out first dispersion compensation (step S10). For example, the first compensation unit 312 obtains the capture signal from the capture memory 311. Upon acquisition of the capture signal, the first compensation unit 312 compensates for the capture signal with the first setting value set therein, and outputs it as a monitor signal.

When the first compensation unit 312 carries out the first dispersion compensation, the non-linear compensation unit 313 carries out non-linear compensation (step S11). For example, the non-linear compensation unit 313 compensates for the degradation of the optical transmission path 50 caused by the non-linear optical effect by performing phase rotation by an amount obtained by multiplying the square of the amplitude of the monitor signal by a predetermined value. When the non-linear compensation unit 313 carries out the non-linear compensation, the second compensation unit 314 carries out second dispersion compensation (step S12). For example, the second compensation unit 314 compensates for the monitor signal with the second setting value set by the addition unit 323, and outputs it.

When the second compensation unit 314 carries out the second dispersion compensation, the identification unit 315 carries out identification/symbol reproduction processing (step S13). For example, the identification unit 315 obtains the capture signal retained by the capture memory 311, reproduces the symbol from the capture signal, and demodulates the capture signal by identifying the value of each symbol to reproduce the transmission signal. Upon reproduction of the transmission signal, the identification unit 315 outputs the transmission signal as a reference signal. When the identification unit 315 outputs the reference signal, the third compensation unit 316 carries out third dispersion compensation (step S14). For example, the third compensation unit 316 compensates for the reference signal with the additional compensation amount set by the compensation amount determination unit 322, and outputs it.

When the third compensation unit 316 carries out the third dispersion compensation, the optical power estimation unit 317 calculates a correlation value (step S15). For example, the optical power estimation unit 317 calculates a correlation value of the complex amplitude of the monitor signal and the reference signal. Upon calculation of the correlation value, the optical power estimation unit 317 outputs the calculated correlation value as an optical power estimation value (step S16), and terminates the process. Note that the optical transmission path monitoring device 300 may perform the process of steps S10 to S12 and the process of steps S13 and S14 in parallel.

### Modification of First Embodiment

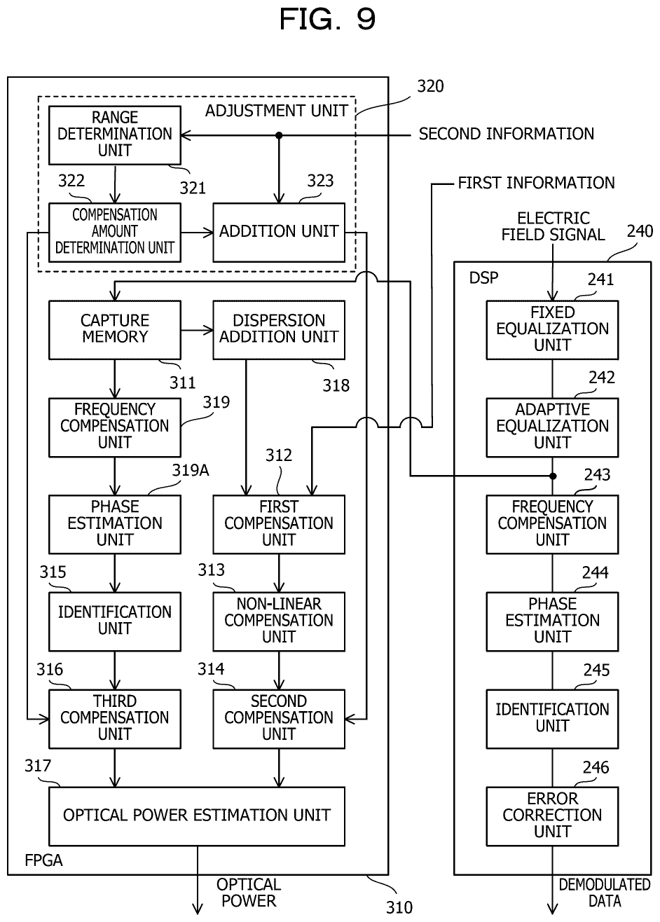

Next, a modification of the first embodiment will be described with reference to FIG. 9. As illustrated in FIG. 9, the capture memory 311 retains the electric field signal output from the adaptive equalization unit 242 as a capture signal. The electric field signal output from the adaptive equalization unit 242 is a signal after the wavelength dispersion is compensated by the fixed equalization unit 241. Thus, the dispersion amount of the wavelength dispersion included in the capture signal is 0 ps/nm.

Furthermore, the modification of the first embodiment is different from the first embodiment in that the FPGA 310 includes a dispersion addition unit 318, a frequency compensation unit 319, and a phase estimation unit 319A. The dispersion addition unit 318 obtains the capture signal from the capture memory 311, and compensates for the dispersion amount of the wavelength dispersion of the capture signal with the dispersion addition amount of the entire optical transmission path 50 described above. Thus, according to this modification, the first dispersion compensation amount input value described above is set as the first information alone in the first compensation unit 312.

The frequency compensation unit 319 performs processing similar to that of the frequency compensation unit 243 described in the first embodiment. Furthermore, the phase estimation unit 319A performs processing similar to that of the phase estimation unit 244 described in the first embodiment. As described above, according to the modification, the capture memory 311 retains the electric field signal output from the adaptive equalization unit 242 as a capture signal. Thus, the frequency compensation unit 319 and the phase estimation unit 319A perform processing similar to the processing performed at the subsequent stage of the adaptive equalization unit 242. Even with such a configuration of the modification, the optical transmission path monitoring device 300 may ensure the effects similar to those of the first embodiment.

### Second Embodiment

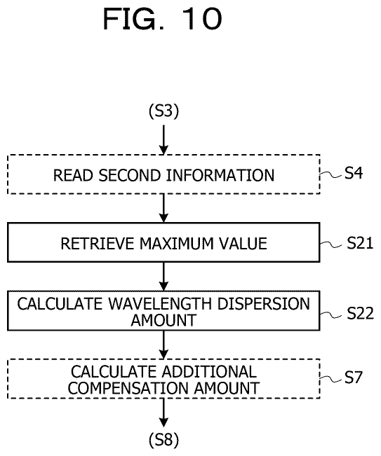

A second embodiment of the present case will be described with reference to FIGS. 10 to 12. In FIG. 10, processing similar to the processing described with reference to FIG. 8 is denoted by the same reference sign, and detailed descriptions thereof will be omitted. This also similarly applies to embodiments to be described later. While the exemplary case where the dispersion coefficient is positive has been described as an example of the optical fiber in the first embodiment and the modification thereof, in the second embodiment, an exemplary optical fiber in which the dispersion coefficient is negative will be described. For example, a dispersion shifted fiber having a negative dispersion coefficient is known as an optical fiber having a negative dispersion coefficient, for example.

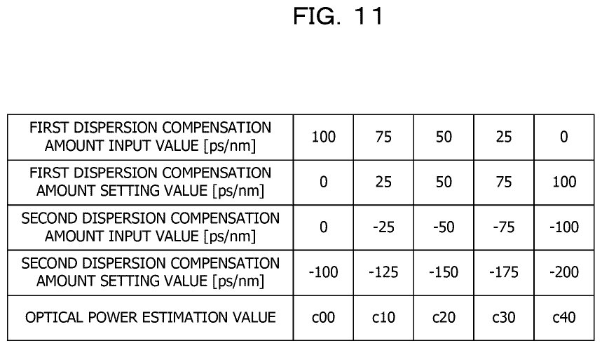

First, as illustrated in FIG. 10, upon execution of processing of step S4, a range determination unit 321 searches for the maximum value (step S21). In the second embodiment, as illustrated in FIG. 11, the range determination unit 321 reads second dispersion compensation amount input values from 0 ps/nm to −100 ps/nm at intervals of −25 ps/nm. Thus, when the range determination unit 321 searches for the maximum value, the range determination unit 321 identifies 0 ps/nm as a search result.

After the maximum value is searched for, a compensation amount determination unit 322 calculates a wavelength dispersion amount (step S22). For example, the compensation amount determination unit 322 calculates a wavelength dispersion amount obtained by adding a predetermined value to the maximum value. In the second embodiment, for example, 100 ps/nm is adopted as an example of the predetermined value. As a result, for example, the compensation amount determination unit 322 calculates 100 ps/nm as the wavelength dispersion amount. Upon calculation of the wavelength dispersion amount, the compensation amount determination unit 322 performs the processing of step S7 described above in a similar manner to the first embodiment. For example, the compensation amount determination unit 322 calculates an additional compensation amount by inverting a sign of the wavelength dispersion amount. Thus, in the second embodiment, −100 ps/nm is calculated as the additional compensation amount.

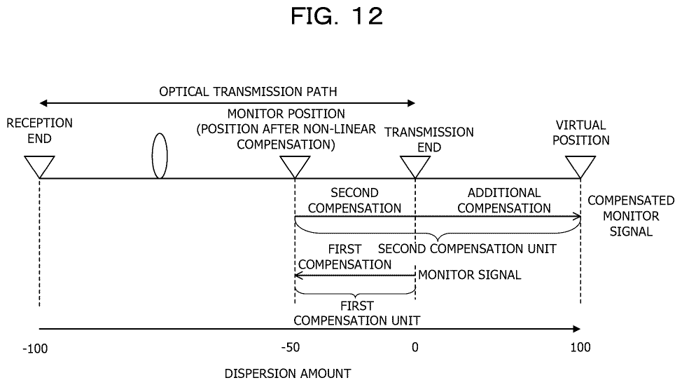

As a result, as illustrated in FIG. 12, an estimated value of optical power is calculated at a virtual position in the vicinity of a transmission end deviated from an optical transmission path 50. In FIG. 12, contrary to FIG. 4, a left-pointing arrow indicates a positive compensation amount of wavelength dispersion, and a right-pointing arrow indicates a negative compensation amount of wavelength dispersion. According to the second embodiment, even in the case of the dispersion shifted fiber having a negative dispersion coefficient or the like, an optical transmission path monitoring device 300 may accurately estimate the optical power in the vicinity of the transmission end.

For example, in a case of dispersion compensation in a frequency domain, fast Fourier transform (FFT) is used, which needs a large number of sample points. Therefore, when the estimated value of the optical power is calculated in a similar manner to the first embodiment, an amount of calculation increases. However, according to the second embodiment, even in the case of the dispersion shifted fiber having a negative dispersion coefficient or the like, the estimated value of the optical power may be calculated by processing similar to that of the first embodiment only by changing the subtraction of the predetermined value from the minimum value to the addition of the predetermined value to the maximum value. As a result, the optical transmission path monitoring device 300 is enabled to suppress an increase in the amount of calculation.

### Third Embodiment

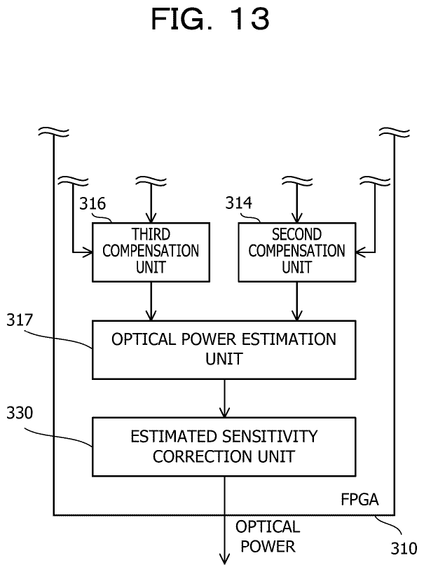

A third embodiment of the present case will be described with reference to FIGS. 13 to 15. In the third embodiment, as illustrated in FIG. 13, an estimated sensitivity correction unit 330 is provided in an FPGA 310. The estimated sensitivity correction unit 330 corrects estimated sensitivity of an estimated value of optical power output by an optical power estimation unit 317. As a result, as compared with the first embodiment, an optical transmission path monitoring device 300 is enabled to more accurately estimate the optical power in the vicinity of a transmission end.

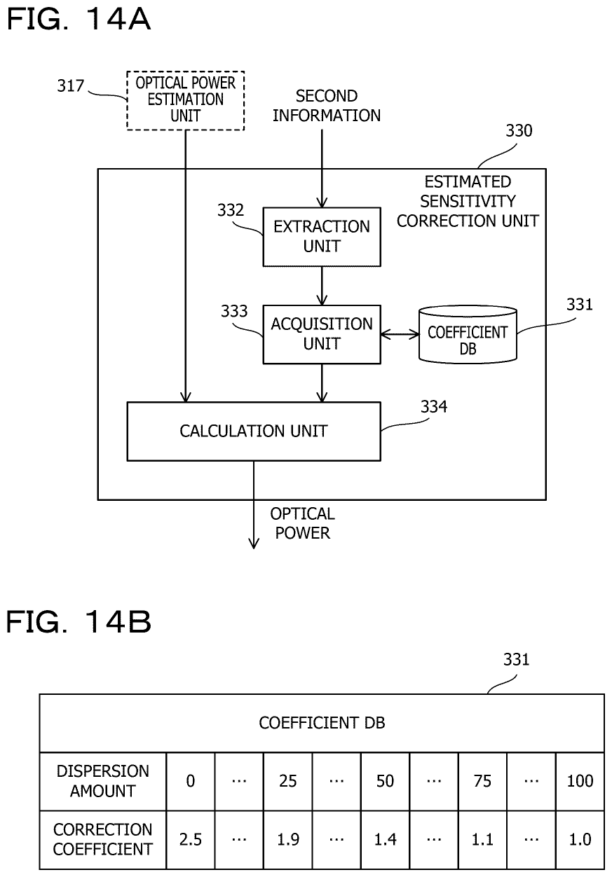

As illustrated in FIG. 14A, the estimated sensitivity correction unit 330 includes a coefficient DB 331, an extraction unit 332, an acquisition unit 333, and a calculation unit 334. As illustrated in FIG. 14B, the coefficient DB 331 stores a correction coefficient for each dispersion amount (e.g., cumulative dispersion amount) from the transmission end. According to the coefficient DB 331, the correction coefficient decreases as the dispersion amount from the transmission end increases.

The extraction unit 332 obtains second information described in the first embodiment. For example, the extraction unit 332 obtains a second dispersion compensation amount input value (see FIG. 5) as the second information. Upon acquisition of the second information, the extraction unit 332 extracts the dispersion amount at a monitor position, and outputs it to the acquisition unit 333.

The acquisition unit 333 obtains a correction coefficient corresponding to the dispersion amount from the coefficient DB 331 based on the dispersion amount output from the extraction unit 332. Upon acquisition of the correction coefficient, the acquisition unit 333 outputs the correction coefficient associated with the dispersion amount to the calculation unit 334.

The calculation unit 334 obtains the estimated value of the optical power for each dispersion amount output from the optical power estimation unit 317. Upon acquisition of the estimated value of the optical power, the calculation unit 334 corrects and outputs the estimated sensitivity of the estimated value of the optical power based on the correction coefficient output from the acquisition unit 333. For example, the calculation unit 334 corrects the estimated sensitivity of the estimated value of the optical power by multiplying the estimated value of the optical power by the correction coefficient, and outputs it. The calculation unit 334 may correct the estimated sensitivity of the estimated value of the optical power by adding the correction coefficient to the estimated value of the optical power, and may output it.

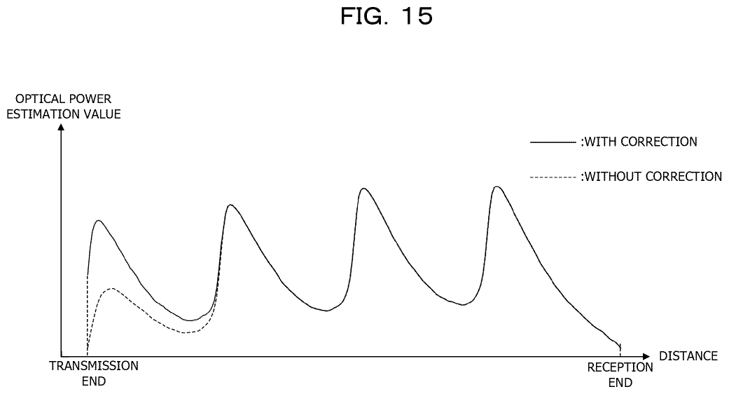

As a result, as illustrated in FIG. 15, as compared with the case where no correction is made by the estimated sensitivity correction unit 330, the optical transmission path monitoring device 300 according to the third embodiment is enabled to more accurately estimate the optical power in the vicinity of the transmission end.

### Fourth Embodiment

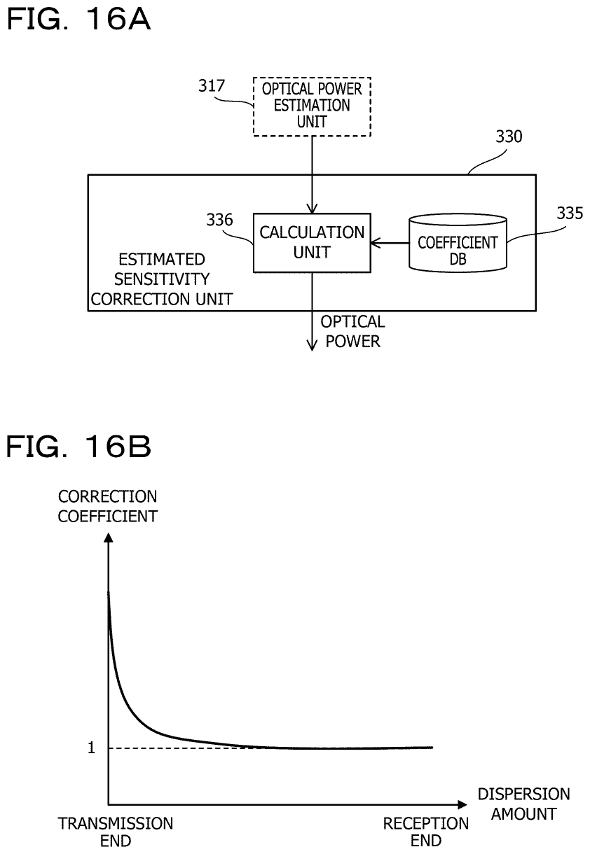

A fourth embodiment of the present case will be described with reference to FIGS. 16A and 16B. Unlike the third embodiment, an estimated sensitivity correction unit 330 may include a coefficient DB 335 and a calculation unit 336 as illustrated in FIG. 16A. The coefficient DB 335 stores coefficients α and β of a correction function. The coefficients α and β are determined in advance according to design or the like. The calculation unit 336 includes a correction function Rᵢ′=Rᵢe^{-αCd_i}+β in which a dispersion amount is Cd_i and an estimated value of optical power is Rᵢ. As illustrated in FIG. 16B, when the coefficients α and β of the correction function are determined, the correction function may be represented by a function in which the correction coefficient decreases according to an increase in the dispersion amount from a transmission end.

When a combination of the dispersion amount and the estimated value of the optical power is input from an optical power estimation unit 317 to the calculation unit 336, the calculation unit 336 obtains the coefficients α and β of the correction function from the coefficient DB 335. Upon acquisition of the coefficients α and β of the correction function, the calculation unit 336 calculates and outputs the estimated value Rᵢ′ of the corrected optical power based on the coefficients α and β, the correction function, and the combination of the dispersion amount and the estimated value of the optical power input from the optical power estimation unit 317. As described above, also by the correction using the correction function, an optical transmission path monitoring device 300 is enabled to more accurately estimate the optical power in the vicinity of the transmission end in a similar manner to the case of the third embodiment.

### Fifth Embodiment

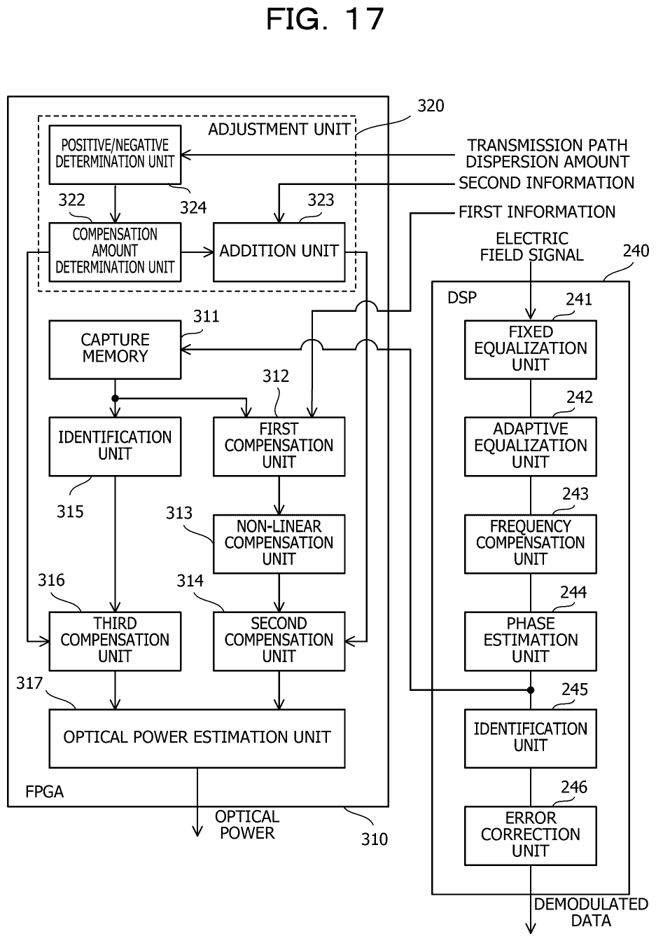

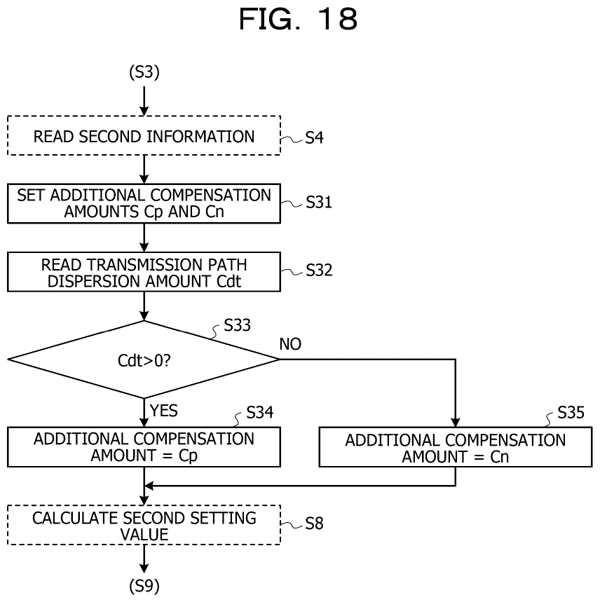

A fifth embodiment of the present case will be described with reference to FIGS. 17 and 18. As illustrated in FIG. 17, an adjustment unit 320 according to the fifth embodiment includes a positive/negative determination unit 324 instead of a range determination unit 321.

A transmission path dispersion amount used when a fixed equalization unit 241 performs dispersion compensation is input to the positive/negative determination unit 324. A transmission path compensation amount used when the fixed equalization unit 241 performs dispersion compensation may be input to the positive/negative determination unit 324. A sign of the transmission path dispersion amount may be positive, or may be negative. When the transmission path dispersion amount is input, the positive/negative determination unit 324 determines whether the transmission path dispersion amount is positive or negative, and outputs either a positive or negative sign to a compensation amount determination unit 322.

Additional compensation amounts Cp and Cn corresponding to the sign of the transmission path dispersion amount are set in advance in the compensation amount determination unit 322. For example, the additional compensation amount Cp is set when the sign of the transmission path dispersion amount is positive, and the additional compensation amount Cn is set when the sign of the transmission path dispersion amount is negative. The compensation amount determination unit 322 selects and determines one of the additional compensation amounts Cp and Cn based on the positive or negative sign input from the positive/negative determination unit 324. For example, when the positive sign is input, the compensation amount determination unit 322 selects and determines the additional compensation amount Cp. When the negative sign is input, the compensation amount determination unit 322 selects and determines the additional compensation amount Cn. The compensation amount determination unit 322 outputs one of the determined additional compensation amounts Cp and Cn to a third compensation unit 316 and to an addition unit 323.

As illustrated in FIG. 18, for example, when the addition unit 323 performs the processing of step S4, the compensation amount determination unit 322 sets the additional compensation amounts Cp and Cn to itself (step S31). The compensation amount determination unit 322 may set the additional compensation amounts Cp and Cn from a lookup table included in an optical reception device 200, or may set them from an external device coupled to the optical reception device 200. The compensation amount determination unit 322 may set the additional compensation amounts Cp and Cn before performing the processing of step S4. For example, the compensation amount determination unit 322 may set the additional compensation amounts Cp and Cn before performing the processing of step S1.

When the compensation amount determination unit 322 sets the additional compensation amounts Cp and Cn, the positive/negative determination unit 324 reads a transmission path dispersion amount Cdt (step S32). The positive/negative determination unit 324 may set the transmission path dispersion amount Cdt from a lookup table included in the optical reception device 200, or may set it from an external device coupled to the optical reception device 200. Upon reading of the transmission path dispersion amount Cdt, the positive/negative determination unit 324 determines whether or not the transmission path dispersion amount Cdt is positive (step S33).

If the transmission path dispersion amount Cdt is positive (YES in step S33), the compensation amount determination unit 322 selects and determines the additional compensation amount Cp from the additional compensation amounts Cp and Cn (step S34). On the other hand, if the transmission path dispersion amount Cdt is negative (NO in step S33), the compensation amount determination unit 322 selects and determines the additional compensation amount Cn from the additional compensation amounts Cp and Cn (step S35). Upon determination of one of the additional compensation amounts Cp and Cn, the compensation amount determination unit 322 sets one of the determined additional compensation amounts Cp and Cn in the third compensation unit 316. Furthermore, upon determination of one of the additional compensation amounts Cp and Cn, the compensation amount determination unit 322 outputs one of the determined additional compensation amounts Cp and Cn to the addition unit 323. When one of the additional compensation amounts Cp and Cn is output from the compensation amount determination unit 322, the addition unit 323 performs the processing of S8 to calculate a second setting value.

As described above, according to the fifth embodiment, the additional compensation amount is determined by the positive and negative signs indicated by the transmission path dispersion amount used when the fixed equalization unit 241 performs the dispersion compensation. Therefore, the process of steps S5 to S7 described in the first embodiment is excluded. For example, the search processing and the calculation processing are omitted. As a result, as compared with the first embodiment, a processing load of an optical transmission path monitoring device 300 may be reduced.

### Sixth Embodiment

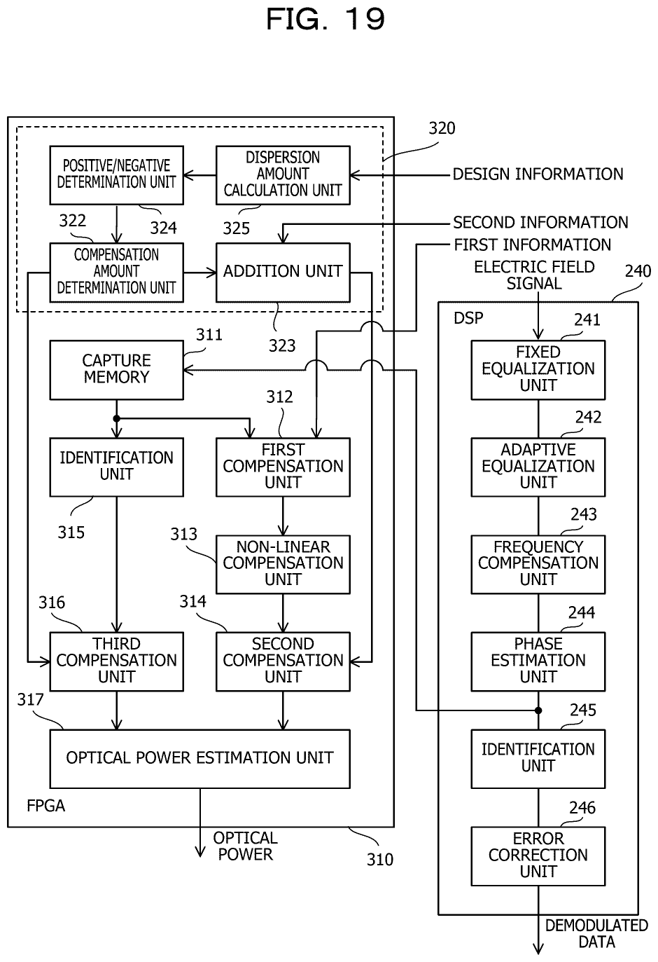

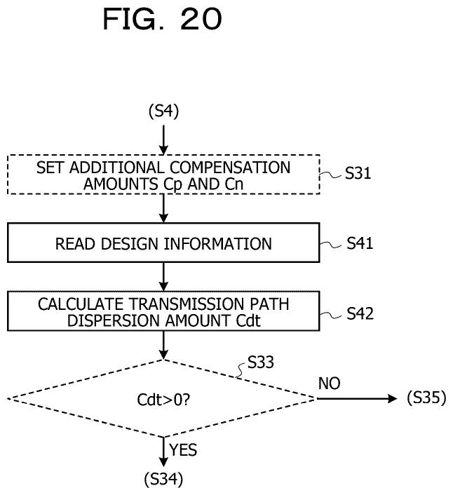

A sixth embodiment of the present case will be described with reference to FIGS. 19 and 20. As illustrated in FIG. 19, an adjustment unit 320 according to the sixth embodiment is different from the fifth embodiment in that a dispersion amount calculation unit 325 is further included.

Design information of an optical transmission path 50 is input to the dispersion amount calculation unit 325. The design information includes, for example, respective fiber lengths and respective dispersion coefficients of optical fibers 51F, 52F, 53F, and 54F. The design information may include respective dispersion amounts of the optical fibers 51F, 52F, 53F, and 54F instead of the fiber lengths and the dispersion coefficients. The dispersion amount calculation unit 325 calculates a transmission path dispersion amount, which is a dispersion amount of the entire optical transmission path 50, based on the design information. Upon calculation of the transmission path dispersion amount, the dispersion amount calculation unit 325 outputs the calculated transmission path dispersion amount to a positive/negative determination unit 324.

As illustrated in FIG. 20, when a compensation amount determination unit 322 performs the processing of step S31, the dispersion amount calculation unit 325 reads the design information (step S41). The dispersion amount calculation unit 325 may read the design information from a memory included in an optical reception device 200, or may read it from an external device coupled to the optical reception device 200. Upon reading of the design information, the dispersion amount calculation unit 325 calculates a transmission path dispersion amount Cdt (step S42). For example, when the design information includes the fiber length and the dispersion coefficient, the dispersion amount calculation unit 325 calculates the sum of products of the fiber length and the dispersion coefficient as the transmission path dispersion amount Cdt. When the transmission path dispersion amount Cdt is calculated, the positive/negative determination unit 324 performs the processing of step S33, and determines whether or not the transmission path dispersion amount Cdt is positive.

As described above, an optical transmission path monitoring device 300 according to the sixth embodiment may use the transmission path dispersion amount calculated based on the design information instead of the transmission path dispersion amount used when a fixed equalization unit 241 performs dispersion compensation. Even in such a sixth embodiment, the process of steps S5 to S7 described in the first embodiment is excluded. Therefore, also in the sixth embodiment, processing load of the optical transmission path monitoring device 300 may be reduced as compared with the first embodiment.

While the preferred embodiments have been described in detail thus far, the embodiments are not limited to specific embodiments, and various modifications and alterations may be made within the scope of the embodiments described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission path monitoring device comprising:
a first compensation circuit that compensates for a part of wavelength dispersion of an optical transmission path with respect to an electric field signal that indicates an optical electric field component of an optical signal obtained by digital coherent reception from the optical transmission path;
a non-linear compensation circuit that compensates for degradation of the optical transmission path caused by a non-linear optical effect with respect to the electric field signal compensated by the first compensation circuit;
a second compensation circuit that compensates for remaining wavelength dispersion of the optical transmission path excluding the part of the wavelength dispersion with respect to the electric field signal compensated by the non-linear compensation circuit, and additionally compensates for wavelength dispersion at a virtual position deviated from the optical transmission path with respect to the compensated electric field signal;
an adjustment circuit that adjusts a compensation amount additionally compensated by the second compensation circuit;
a third compensation circuit that compensates for the wavelength dispersion of the compensation amount with respect to a reference signal that indicates the optical electric field component of the optical signal at a transmission end of the optical transmission path; and
an estimation circuit that estimates optical power in a vicinity of the transmission end based on a correlation of amplitude between a first signal output from the second compensation circuit and a second signal output from the third compensation circuit.

2. The optical transmission path monitoring device according to claim 1, further comprising:
a correction circuit that corrects, after the optical power is estimated, estimated sensitivity of the optical power based on a correction coefficient that decreases according to an increase in a dispersion amount from the transmission end.

3. The optical transmission path monitoring device according to claim 2, wherein the correction circuit includes a database that stores the correction coefficient that decreases according to the increase in the dispersion amount from the transmission end.

4. The optical transmission path monitoring device according to claim 2, wherein the correction circuit corrects the estimated sensitivity of the optical power based on a correction function in which the correction coefficient decreases according to the increase in the dispersion amount from the transmission end.

5. The optical transmission path monitoring device according to claim 1, wherein the adjustment circuit determines whether an input dispersion amount of the optical transmission path is positive or negative, and sets the compensation amount determined based on a determination result in the second compensation circuit.

6. The optical transmission path monitoring device according to claim 1, wherein the adjustment circuit calculates a total dispersion amount of the optical transmission path based on input design information of the optical transmission path, determines whether the total dispersion amount is positive or negative, and sets the compensation amount determined based on a determination result in the second compensation circuit.

7. The optical transmission path monitoring device according to claim 1, further comprising:
a detection circuit that detects a position of an abnormal loss generated in the vicinity of the transmission end based on the optical power.

8. An optical transmission path monitoring method comprising:
compensating for a part of wavelength dispersion of an optical transmission path with respect to an electric field signal that indicates an optical electric field component of an optical signal obtained by digital coherent reception from the optical transmission path; compensating for degradation of the optical transmission path caused by a non-linear optical effect with respect to the compensated electric field signal; compensating for remaining wavelength dispersion of the optical transmission path excluding the part of the wavelength dispersion with respect to the compensated electric field signal;
additionally compensating for wavelength dispersion at a virtual position deviated from the optical transmission path with respect to the compensated electric field signal;
adjusting a compensation amount additionally compensated;
compensating for the wavelength dispersion of the compensation amount with respect to a reference signal that indicates the optical electric field component of the optical signal at a transmission end of the optical transmission path; and
estimating optical power in a vicinity of the transmission end based on a correlation of amplitude between a first signal that is the electric field signal after the additional compensation and a second signal that is the reference signal after the wavelength dispersion of the compensation amount is compensated.
